(19) United States
(12) Patent Application Publication
(10) Pub. No.: US 2015/0050840 A1
(43) Pub. Date: Feb. 19, 2015

(54) Card Connector and Connector

(71) Applicant: Tyco Electronics Japan G.K., Kanagawa (JP)

(72) Inventors: Junya Tsuji, Tokyo (JP); Tokuhiro Hayashimoto, Kanagawa (JP); Yutaka Okoshi, Kanagawa (JP)

(73) Assignee: Tyco Electronics Japan G.K., Kanagawa (JP)

(21) Appl. No.: 14/460,930

(22) Filed: Aug. 15, 2014

(30) Foreign Application Priority Data
Aug. 16, 2013 (JP) 2013-169097

(51) Int. Cl. H01R 12/72; H01R 13/05

(52) U.S. Cl. CPC H01R 12/722; H01R 13/05
USPC 439/629; 439/786

(57) ABSTRACT

A card connector is provided and includes a case and a plurality of contacts. The case includes a card receiving section, while each of the plurality of contacts include a first resilient beam, a second resilient beam, and a bridge part. The second resilient beam has a length longer than the first resilient beam. The bridge part connects the first resilient beam and the second resilient beam.

### CROSS-REFERENCE TO RELATED APPLICATIONS

This application claims the benefit of the filing date under 35 U.S.C. §119(a)-(d) of Japanese Patent Application No. 2013-169097, filed Aug. 16, 2013.

### FIELD OF THE INVENTION

The invention relates to a electrical connector and, more particularly, to a card connector for a data storage device.

### BACKGROUND

Data storage devices, such as memory cards, are continually being reduced in size, all the while maintaining the same function or even having added functions. For instance, there was a transition from micro SIM (subscriber identity module) cards to a smaller-sized nano SIM cards. For devices having a card connector adapted to micro SIM cards, it is the smaller-sized nano SIM cards that are often desired for use. Since this usage is not included in the warranty by a carrier (or telephone company), consumers take self-responsibility for this usage. In this case, an adaptor having the same outer shape as that of a micro SIM card and capable of receiving a nano SIM card therein is used. With the use of the adaptor, the nano SIM card can be used with a card connector adapted to micro SIM cards.

The adaptor as described above does not have standards regarding to dimensions and the like. Thus, depending on the adaptor, an unevenness may occur due to different dimensions between the adaptor and the nano SIM card loaded in the adaptor. In this case, when the adaptor (with the nano SIM card) is ejected from the card connector, a contact of the card connector may be caught in that unevenness. When a free end of the contact is caught in the unevenness, the contact may become buckled or damaged, leading to a failure of the card connector.

Accordingly, to prevent buckling or damage of the contact as described above, the contact may have a structure similar to that of a double-supported beam as disclosed in JP 6-9069 U, which prevent the free end of the contact from being caught in the unevenness.

However, the contact having the structure similar to that of the double-supported beam has a problem, in that the known design promotes high contact pressure onto the card. To decrease the contact pressure to a satisfactory value, a longer beam length is required. To increase the beam length, a larger space is required for the contact.

### SUMMARY

Therefore, the invention was made in view of the above-described problem, among others.

A card connector is provided and includes a case and a plurality of contacts. The case includes a card receiving section, while each of the plurality of contacts include a first resilient beam, a second resilient beam, and a bridge part. The second resilient beam has a length longer than the first resilient beam. The bridge part connects the first resilient beam and the second resilient beam.

### BRIEF DESCRIPTION OF THE DRAWINGS

The above and other features of the present invention will become more apparent by describing in detail exemplary embodiments thereof with reference to the accompanying drawing, in which:

FIG. 1 is a perspective view of a card connector according to the invention;

FIG. 2 is a plan view of the card connector of FIG. 1;

FIG. 3 is a sectional view of the card connector of FIG. 2, taken along line 3-3;

FIG. 4 is a perspective view of the card connector of FIG. 1 with a shell removed there from;

FIG. 5 is a perspective view of a first contact of the card connector of FIG. 1;

FIG. 6 is a perspective view of a second contact of the card connector of FIG. 1;

FIG. 7 is a sectional view of the card connector according to the invention, before an adaptor is ejected there from;

FIG. 8 is another sectional view of the card connector according to the invention, showing the adaptor abutting a first resilient beam;

FIG. 9 is another sectional view of the card connector according to the invention, showing the first resilient beam urged by the adaptor;

FIG. 10 is another sectional view of the card connector according to the invention, showing the adaptor abutting a second resilient beam;

FIG. 11 is another sectional view of the card connector according to the invention, showing the second resilient beam urged by the adapter; and

FIG. 12 is another sectional view of the card connector according to the invention, showing the first resilient beam and the second resilient beam completely deflected by the adaptor.

### DETAILED DESCRIPTION OF THE EMBODIMENT(S)

The present invention is exemplarily described below with reference to the attached drawings.

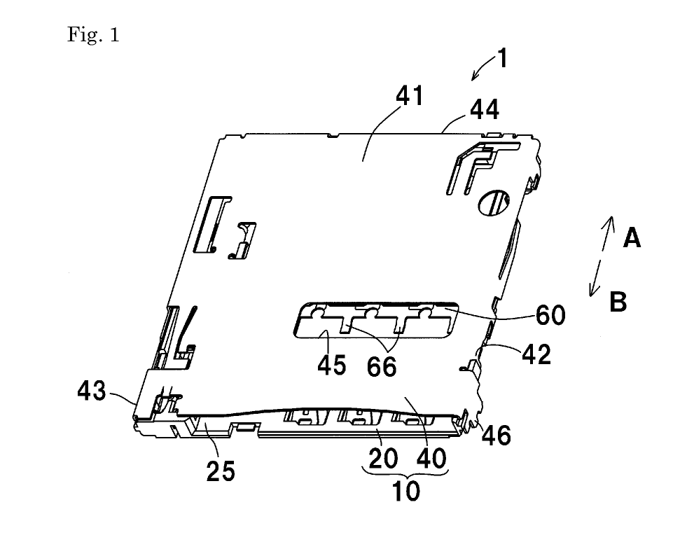

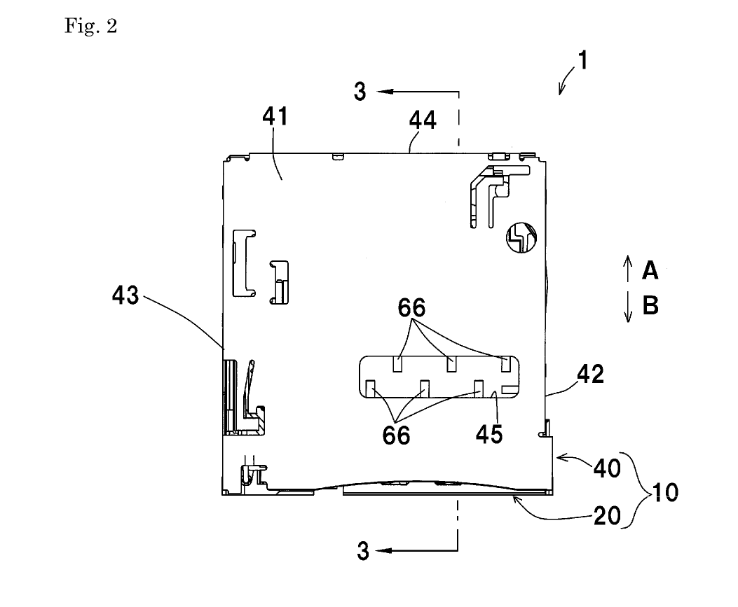

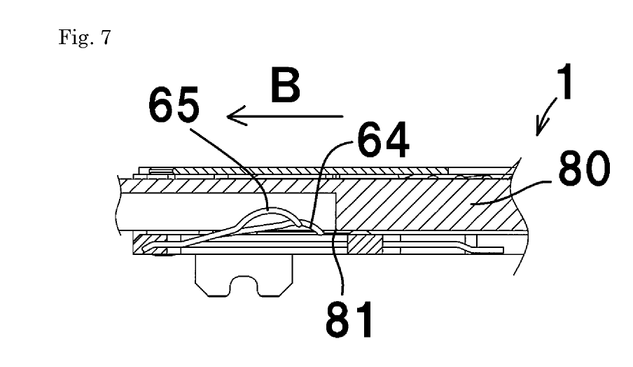

With reference to FIGS. 1-4, the card connector 1 according to an embodiment of the invention is shown. The card connector may be mounted on, for example, a potable device such as a mobile phone with a micro SIM card (or an adaptor 80 receiving a nano SIM card (see FIG. 7 to FIG. 12)) received therein. As shown, the card connector 1 includes a case 10 and contacts 60. The case 10 includes a housing 20 and a shell 40. A receiving space for receiving a micro SIM card or an adaptor therein is defined between the housing 20 and the shell 40.

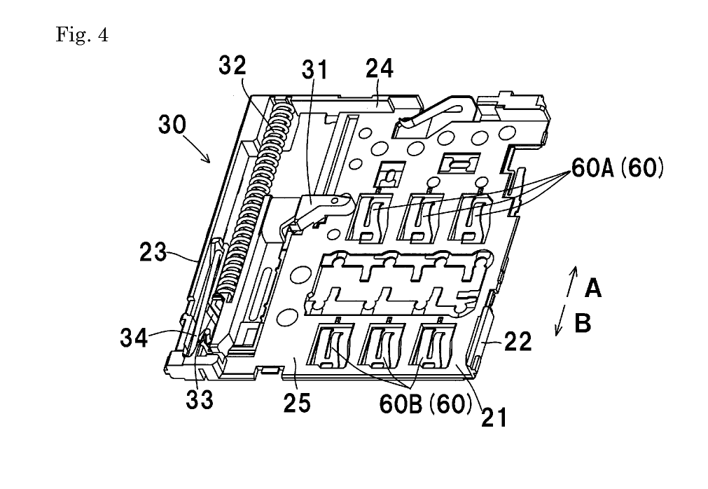

With reference to FIG. 4, the housing 20 may be formed from a synthetic resin, and may have a rectangular parallelepiped shape, for example. A card receiving section 25 for a card is provided at an approximate center portion of the housing 20. The card receiving section 25 is defined by a bottom wall 21, a right-side wall 22, a left-side wall 23, and a rear wall 24 is formed. An eject mechanism 30 for ejecting an inserted card is disposed on the left side of the card receiving section 25. In the shown embodiment, the eject mechanism 30 is a so-called push-push-type eject mechanism, and includes a slider 31, a spring 32, a heart-shaped cam groove 33, and a rod 34 engaged with the cam groove 33. The slider 31 is slidable in the housing 20 in an inserting direction A and an ejecting direction B, and abuts a card to eject the card in the ejecting direction B. The spring 32 is disposed between the rear wall 24 and the slider 31 to bias the slider 31 in the ejecting direction B. The cam groove 33 is formed in the slider 31, and is engaged with one end of the rod 34 to determine a lock position and an eject position of the slider 31. The rod 34 has one end engaged with the cam groove 33 and the other end pivotally mounted on the housing 20. This eject mechanism 30 is a known structure, and therefore is not described further in detail.

With reference to FIGS. 1-3, the shell 40 is formed by stamping and forming a conductive metal plate. The shell includes an upper wall 41, and a right wall 42, a left wall 43, and a rear wall 44 formed by folding the upper wall 41. An opening 45 is formed at an approximate center of the upper wall 41, which allows a visual inspection of board connecting portions 66 of the contacts 60 and a repair of their solder connecting portions. On a front side (a tip side along the ejecting direction B) of each of the right wall 42 and the left wall 43, a solder peg 46 is formed so as to protrude there from. The solder peg 46 may be inserted and soldered into a through hole (not shown) of a circuit board (not shown) on which the card connector is mounted.

With reference again to FIG. 4, the contacts 60 (60A and 60B) are held in the housing 20. The contacts 60 (60A and 60B) may be insert-molded in the bottom wall 21 of the housing 20. The contacts 60 are formed of first contacts 60A arranged on a rear side of the receiving space 25 and second contacts 60B arranged on a front side of the receiving space 25.

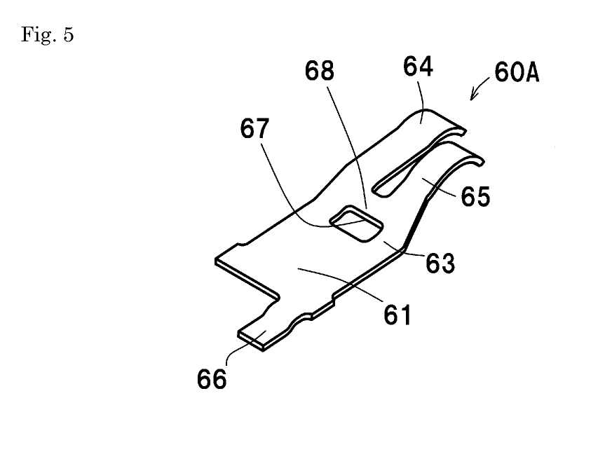

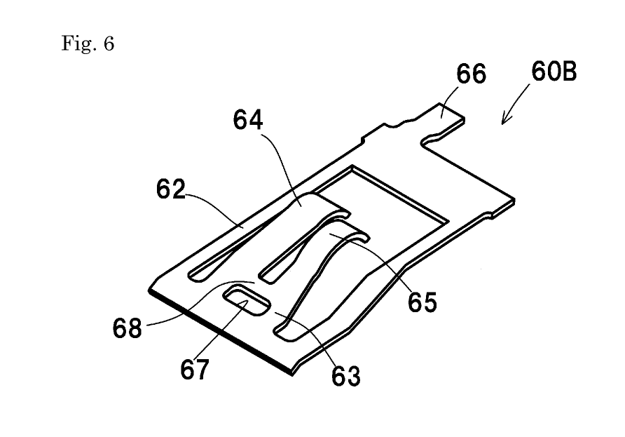

With reference to FIGS. 5 and 6, the first contact 60A and the second contact 60B are shown, and each may include a securing portion 61 (62), a resilient base section 63, two resilient beams 64 and 65, and the board connecting portion 66. However, the first contact 60A and the second contact 60B have a difference in the shapes of the securing portion 61 (62) and the board connecting portion 66. In the shown embodiment, the securing portion 61 has an approximate rectangular flat plate shape (see FIG. 5). While the resilient base section 63 extends along the inserting direction A (see FIG. 4) from one end of the securing portion 61, the board connecting portion 66 extends along the ejecting direction B (see FIG. 4) from the other end of the securing portion 61. In contrast, the securing portion 62 has an approximate rectangular frame shape, as shown in FIG. 6. Also, while the resilient base section 63 extends in the inserting direction A from one end of an inner edge of the securing portion 61, the board connecting portion 66 extends along the inserting direction A from the other end of an outer edge of the securing portion 61.

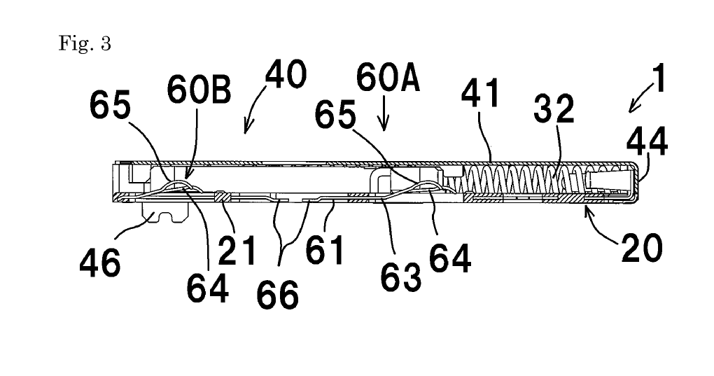

Except for the above-described points, the first contact 60A and the second contact 60B are similar to each other. Therefore, the contact 60 represents the first contact 60A, and only the first contact 60A is described in the following. An opening 67 is provided at an approximate center of the resilient base section 63, in order to decrease the material width to reduce stiffness. The two resilient beams 64 and 65 extend parallel to each other, with both extending from one end of the resilient base section 63 along the inserting direction A. The first resilient beam 64 on the left is longer than the second resilient beam 65 on the right. As clearly shown in FIG. 3, the top of an arc-shaped section extending upward (convex) and positioned near a free end of the shorter second resilient beam 65 is positioned higher than the top of an arc-shaped section extending upward (convex) and positioned near a free end of the longer first resilient beam 64. This is because only the shorter second resilient beam 65 makes contact with a contact pad (not shown) of the card. On the resilient base section 63, the two resilient beams 64 and 65 are interconnected by a bridge part 68. Thus, as will be described further below, when the longer first resilient beam 64 is deflected downward, the second resilient beam 65 is also deflected downward together via the bridge part 68.

With reference to FIG. 3, the free end of the shorter second resilient beam 65 is slightly overlaid on the arc-shaped section of the longer first resilient beam 64 in a side view, and is positioned higher than the free end of the longer first resilient beam 64. In other words, the free end of the second resilient beam 65 has a small amount of projection from a lower surface near the top of the arc-shaped section of the first resilient beam 64. Thus, when the shorter second resilient beam 65 is deflected downward, the amount of deflecting of the second resilient beam 65 can be ensured. Also, even if the free end of the second resilient beam 65 abuts on the upper surface of the circuit board (not shown) where the card connector 1 is implemented, no excessive counterforce is exerted on the adaptor 80.

Now, with reference to FIGS. 7 through 12, various sectional views are provided to show ejection of the adaptor 80 from the card connector 1.

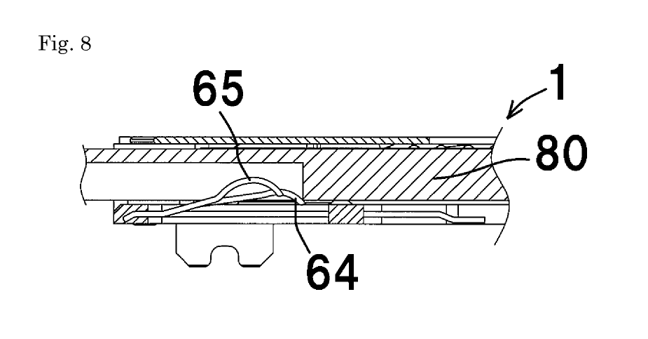

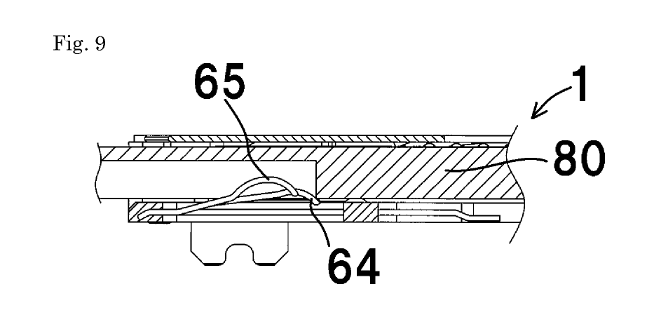

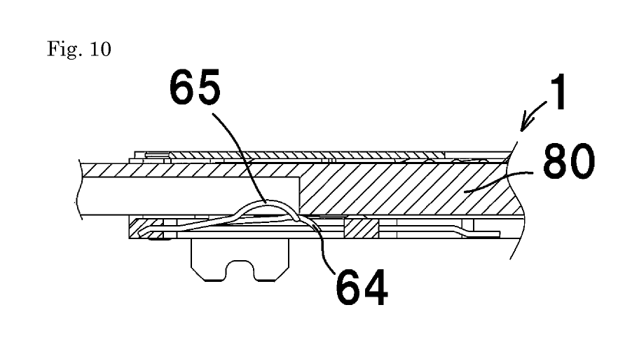

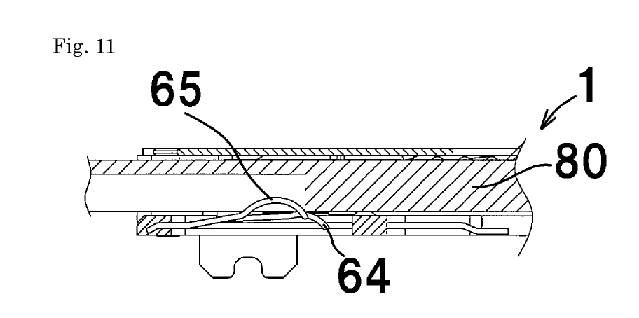

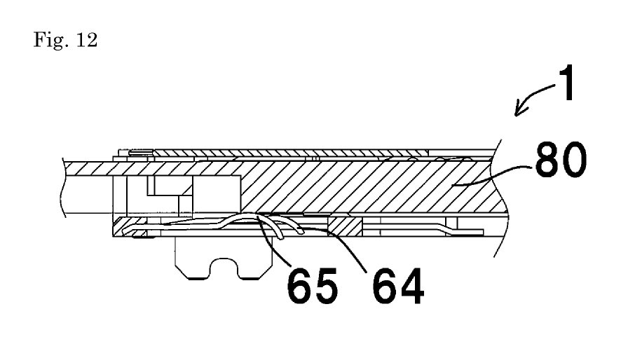

When the adaptor 80 having a nano SIM card loaded therein starts to be ejected along the ejecting direction B (see FIG. 7), an inner edge 81 of the adaptor 80 abuts on the upper surface of the arc-shaped section near the free end of the longer first beam 64 (see FIG. 8). With the adaptor 80 and the first beam 64 engaged together, the first beam 64 starts to be deflected downward. With the first beam 64 and the second beam 65 interconnected by the bridge part 68, the second beam 65 also starts to be deflected downward together (see FIG. 9). When the adaptor 80 further moves along the ejecting direction B, the inner edge 81 of the adaptor 80 abuts on the upper surface of the arc-shaped section near the free end of the shorter second beam 65 (see FIG. 10). Here, the second beam 65 is already deflected downward in conjunction with the first beam 64. Thus, as shown in FIG. 7, even if the free end of the second beam 65 is positioned above the inner edge 81 of the adaptor 80, the free end of the second beam 65 will not collide with the adaptor 80. When the adaptor 80 further moves along the ejecting direction B, with the inner edge 81 of the adaptor 80 and the upper surface of the arc-shaped section near the free end of the second beam 65 engaged together, the second beam 65 further deflects downward (see FIG. 11). Furthermore, when the adaptor 80 moves along the ejecting direction B, the adaptor 80 passes across the top of the arc-shaped section near the free end of the second beam 65 (see FIG. 12). The total amount of deflection of the second beam 65 is achieved. The free end of the second beam 65 does not abut the upper surface of the circuit board nor does it abuts the upper surface of the circuit board with a load. Thus, the arc-shaped section of the second beam 65 is not further deformed, and therefore an excessive counterforce is not exerted on the adaptor 80, as described in the prior art.

While the card connector and its contacts according to the embodiments of the present invention have been described in detail above, it is intended that the present invention is not restricted to these embodiments and can be variously modified. For example, while only the second beam is configured to make contact with the contact pad of the card in the above-described embodiments of the present invention, the first beam may be configured to also make contact with the contact pad. Furthermore, while the case is configured of a resin-made housing and a metal-made shell, the case may be configured of a resin-made housing and a resin-made cover, or the housing and the cover may integrally form the case. Still further, the bridge part 68 may be provided at not the position of the resilient base section 63 but another position.

Although exemplary embodiments have been shown and described, it would be appreciated by those skilled in the art that various changes or modifications may be made in these embodiments without departing from the principles and spirit of the disclosure, the scope of which is defined in the claims and their equivalents.

What is claimed is:

1. A card connector, comprising:
a case having a card receiving section; and
a plurality of contacts secured in the case, each of the plurality of contacts having
a first resilient beam;
a second resilient beam having a length longer than the first resilient beam; and
a bridge part connecting the first resilient beam and the second resilient beam.

2. The card connector according to claim 1, wherein the first resilient beam includes an arc-shaped section proximate a free end thereof.

3. The card connector according to claim 2, wherein the second resilient beam includes an arc-shaped section proximate a free end thereof.

4. The card connector according to claim 3, wherein the free end of the second resilient beam overlays the arc-shaped section of the first resilient beam.

5. The card connector according to claim 4, wherein the free end of the second resilient beam is positioned higher than the free end of the first resilient beam.

6. The card connector according to claim 5, wherein each of the plurality of contacts further includes a securing portion and a resilient base section extending from the securing portion.

7. The card connector according to claim 6, wherein the first resilient beam extends from the resilient base section.

8. The card connector according to claim 7, wherein the second resilient beam extends from the resilient base section.

9. The card connector according to claim 8, wherein the resilient base section includes an opening formed approximately about a center thereof.

10. An electrical contact, comprising:
a first resilient beam;
a second resilient beam having a length longer than the first resilient beam; and
a bridge part connecting the first resilient beam and the second resilient beam.

11. The electrical contact according to claim 10, wherein the first resilient beam includes an arc-shaped section proximate a free end thereof.

12. The electrical contact according to claim 11, wherein the second resilient beam includes an arc-shaped section proximate a free end thereof.

13. The electrical contact according to claim 12, wherein the free end of the second resilient beam overlays the arc-shaped section of the first resilient beam.

14. The electrical contact according to claim 13, wherein the free end of the second resilient beam is positioned higher than the free end of the first resilient beam.

15. The electrical contact according to claim 14, further comprising a securing portion and a resilient base section extending from the securing portion.

16. The electrical contact according to claim 15, wherein the first resilient beam extends from the resilient base section.

17. The electrical contact according to claim 16, wherein the second resilient beam extends from the resilient base section.

18. The electrical contact according to claim 17, wherein the resilient base section includes an opening formed approximately about a center thereof.
